(19) United States
(12) Patent Application Publication
(10) Pub. No.: US 2026/0309925 A1
(43) Pub. Date: Oct. 8, 2026

(54) OPTICAL FIBRE CONNECTOR ASSEMBLY

(71) Applicant: RMSPUMPTOOLS LIMITED, Dyce, Aberdeen (GB)

(72) Inventor: John-Paul Worthington, Ulverston, Cumbria (GB)

(21) Appl. No.: 19/164,156

(22) PCT Filed: Mar. 18, 2024
(86) PCT No.: PCT/GB2024/050733

§ 371 Date: Sep. 10, 2025

(30) Foreign Application Priority Data
Mar. 20, 2023 (GB) 2303998.5

(51) Int. Cl. G02B 6/38

(52) U.S. Cl. CPC G02B 6/3825; G02B 6/3816; G02B 6/3849; G02B 6/3871; G02B 6/3874; G02B 6/3882

(57) ABSTRACT

An optical fibre connector assembly has first and second connector parts adapted to interconnect, each of the first and second connector parts having an axis. A first optical fibre terminates in a first ferrule in the first connector part, and a second optical fibre terminates in a second ferrule in the second connector part, the first and second ferrules being adapted to interengage to transmit a signal between the first and second connector parts. The second connector part has a guide assembly connected to the second ferrule and adapted to guide interengagement of the first and second ferrules, the guide assembly having a pocket adapted to receive the first ferrule during interengagement of the first and second ferrules. At least a part of the guide assembly is rotatable around the axis of the second connector part during interengagement of the first and second ferrules.

### CROSS REFERENCE TO RELATED APPLICATIONS

This application is a filing under 35 U.S.C. 371 of International Application No. PCT/GB 2024/050733 filed Mar. 18, 2024, entitled “OPTICAL FIBRE CONNECTOR ASSEMBLY,” which claims priority to Great Britain Application No. 2303998.5, filed Mar. 20, 2023, which applications are incorporated by reference herein in their entirety.

### FIELD OF DISCLOSURE

The present invention relates to an optical fibre connector assembly for connecting two optical fibres.

### BACKGROUND

Optical fibres to be connected together in a fibre optic connector assembly are typically terminated in a respective optical ferrule in each connector part. Each ferrule can accommodate multiple fibres. The ferrules interengage to mate opposing fibres within the mated connector parts to enable transmission of the optical signal across the made-up connector assembly.

US 2017/0242210 discloses a connector assembly useful for understanding the invention, having a guide assembly to control movement of a ferrule within its connector part during make up. EP2977802 discloses another connector assembly useful for understanding the invention. US20180136412; JP2014063111 and EP1043611 all disclose another connector assembly's useful for understanding the invention, all of which are arranged for use in normal air environments and none of which are adapted for use in harsh environments.

### SUMMARY

The invention provides an optical fibre connector assembly comprising:
first and second connector parts adapted to interconnect, each of the first and second connector parts having an axis;
a first optical fibre terminating in a first ferrule in the first connector part, and a second optical fibre terminating in a second ferrule in the second connector part, the first and second ferrules being adapted to interengage to transmit a signal between the first and second connector parts;
wherein the second connector part comprises a guide assembly connected to the second ferrule and adapted to guide interengagement of the first and second ferrules, the guide assembly having a pocket adapted to receive the first ferrule during interengagement of the first and second ferrules;
and wherein at least a part of the guide assembly is rotatable around the axis of the second connector part during interengagement of the first and second ferrules.

Optionally relative axial movement of the first and second ferrules within the connector assembly drives rotational movement of at least a part of the guide assembly relative to the first ferrule between a first rotational position in which the first ferrule is axially spaced apart from the second ferrule and the first and second ferrules are circumferentially misaligned and in which the first and second optical fibres are not in communication, and a second rotational position in which the first and second ferrules are axially engaged and circumferentially aligned and the first and second optical fibres are in communication.

Optionally the rotatable part of the guide assembly has rotational freedom around the axis of the second connector portion, and the circumferential position adopted by the guide assembly is influenced by forces acting on it. Optionally the pocket is in the rotatable part of the guide assembly.

The guide assembly optionally comprises a guide collar, which can optionally take the form of a sleeve, having a bore with an axis, which is typically co-axial with the axis of the first connector part.

The guide assembly optionally houses the second ferrule. Optionally the guide assembly comprises a body in which the second ferrule is mounted, and optionally a capture cone comprising the pocket. Optionally the ferrule, the body and the capture cone in the guide assembly are rotationally connected, e.g. fixed together, so that they rotate together freely around the axis of the second portion; in other words they are optionally not independently rotatable with respect to each other. Optionally at least a portion of the ferrule can move axially relative to the body and optionally the capture cone, and can optionally be biased in one axial direction with respect to the body and optionally the capture cone by means of a resilient device such as a spring.

Optionally the guide assembly is mounted in the bore of the second connector part, optionally on a bearing assembly (which is typically fixed in the bore) permitting free rotation of the guide assembly within the bore relative to the bearing assembly, around the axis of the second connector part.

Optionally the pocket is radially spaced from the axis of the second connector part. Optionally the pocket is tapered, typically having tapered sides spaced circumferentially apart. Optionally the pocket has one outer end with an opening, and an inner end. Optionally the outer end faces the first connector part and the mating end of the second connector part. Optionally the outer end of the pocket has a mouth which is wider than a throat of the pocket at the opposite inner end of the pocket. Optionally the outer end is adapted to receive the first ferrule and is circumferentially larger than the first ferrule. Optionally the inner end of the pocket is circumferentially no larger, and optionally circumferentially smaller than the first ferrule, and typically the first ferrule cannot freely pass axially through the inner end of the pocket. Optionally as the first ferrule advances into the open end of the pocket, the pocket narrows and (typically gradually) reduces the available space for relative movement between the first and second ferrules, until the first ferrule is in the throat of the pocket, at which point the sides of the pocket typically engage the first ferrule on at least two circumferentially spaced apart sides of the first ferrule, resisting or preventing relative circumferential (and optionally axial) movement between the first and second ferrules, when the first ferrule is in the throat of the pocket.

Optionally the first and second ferrules incorporate more than one optical fibre each, e.g. 2, 3, 4, 5 or 6 or more optical fibres.

Typically the rotatable part of the guide assembly is fixed (optionally rotationally fixed) in relation to the second ferrule, and is rotatable with the second ferrule around the central axis of the second connector part. Optionally the rotatable part of the guide assembly is rotatable relative to both of the first and second connector parts, around a common (optionally central) axis when interconnected. Optionally the range of rotation is limited by a pin fixed to the first connector part, and engaged in a slot (typically a curved slot) in the guide assembly. Optionally the range of rotation is more than 10°, typically more than 20°, typically from 25-35°, and typically less than 40°.

Optionally at least one of the first and second ferrules is arranged to move radially relative to a common axis of the first and second connector parts during mating, for example, between a first radial position in which the distances between the common axis and the first and second ferrules are different, and a second radial position in which the distances between the common axis and the first and second ferrules are the same, without necessarily requiring that the first and second ferrules are in circumferential alignment (in other words, in the second radial position, the first and second ferrules can be at the same radial spacing, but can be circumferentially misaligned).

Preferably, the first ferrule and the first optical fibre terminating therein are housed within a chamber and the second ferrule and the second optical fibre terminating therein are housed within a chamber. More preferably, at least one and preferably both said chambers are sealed when the first and second connector parts are separated from one another. Preferably, at least one and preferably both said chambers are arranged to be sealed when the first and second connector parts are brought into mating connection with one another up until a final stage of mating, such that each of the ferrules are protected from exposure to the outer environment both prior, during and post mating of the first and second connector parts.

Optionally at least one of the ferrules moves out of its chamber during mating. Optionally during mating of the first and second connector parts the ferrules are able to move out of their chambers. Optionally the ferrule in the first portion is adapted to move radially from its chamber during connection, optionally on a pivotable arm, which can optionally be biased radially outwards with respect to the axis of the first connector part by a resilient device such as a spring.

The mating of the first and second parts typically has three stages of alignment with each stage typically improving the degree of alignment of the ferrules. Coarse alignment is typically achieved by inserting a housing (e.g. an outer tubular housing) of the second part (optionally forming a plug) into a bore of a housing (e.g. an outer tubular housing) of the first part (optionally forming a receptacle). Optionally the first part incorporates a pin having a shaft extending axially (optionally coaxial with the axis of the first part) within the bore of the tubular housing of the second part, and the shaft of the pin typically engages and optionally seats on a seal of the second part.

The guide assembly typically houses the second ferrule in the rotatable part of the second connector part. This permits the second ferrule to rotate (for example, with the guide assembly) relative to the axis of the second connector part. The first ferrule in the first connector part is typically rotationally fixed relative to the axis of the first connector part, but is typically mounted on the pivotable arm which is movable radially around a pivot axis within the first connector part, typically being urged radially outwards around the pivot axis by the action of a resilient device such as a spring.

The second ferrule is typically housed in a ferrule housing on the body of the guide assembly, at an inner end of a capture cone. The capture cone and the body are typically tubular. Optionally the pocket is symmetrical and shares a common axis with the second ferrule. Interaction of the first ferrule with the guide assembly, e.g. with the pocket, can typically determine the rotational orientation of the second ferrule with respect to the first and optionally the second connector parts. The interaction of the first and second ferrules can typically constitute an intermediate alignment stage which can adjust and typically improve alignment first and second ferrules before final stage mating of the two. Typically as the first ferrule moves axially into the pocket, it forces the rotationally floating guide assembly to rotate relative to the rotationally static first ferrule as the first ferrule moves axially into the throat, thereby increasing the alignment of the first and second ferrules. Thus, in certain examples, the final rotational position of the second ferrule with respect to the second connector part is determined by the interaction of first ferrule with the guide assembly (typically the pocket) during interconnection, as the second ferrule rotates with the guide assembly to typically match the rotational position of the first ferrule.

The first and second ferrules typically incorporate at least two highly toleranced pins in one ferrule which align with highly tolerance bores in the other ferrule. This ensures that first contact of the fibres of both halves of the connector are adjacent and aligned. This stage can be considered the final fine alignment stage of the mate.

The first connector part is typically fixed to the well, e.g. at a wellhead, or other manifold. Optionally the first connector part forms a receptacle, and the second connector part forms a plug. Optionally the first connector part has a capture cone at the mating end facing toward the second connector part. The first and second connector parts are brought into rough circumferential alignment with each other, for example, by roughly aligning outer markers on the outer housings, before the bullnose on the second connector part enters the bore of the first part. Precise circumferential alignment at this stage is unnecessary, and it is sufficient that the relative circumferential alignment between the first and second connector parts is relatively coarse, e.g. ±10-30° e.g. ±15°, since more precise circumferential alignment can be achieved in later stages of the mate.

The first connector part optionally has central bore with an axial pin having a shaft on which a sliding sleeve is mounted within the bore. A bullnose on the end of the outer tubular housing on the second connector part typically moves into the bore of the first connector part and seats on an outer end of the sliding sleeve, which is typically held in its axial position within the bore e.g. by a snap ring. The interaction provides the first stage of coarse alignment between the two connector parts. The minor diameter of the capture cone on the outer housing of the receptacle of the first connector part typically has a close tolerance for example, within 10%, or 5%, or 1-2% with the outer diameter of the second connector part, so that the passage of the bullnose of the second connector part into the capture cone of the first connector part aligns the two connector parts on a common central axis.

As the second connector part continues to advance into the bore of the first connector part, the snap ring holding the sliding sleeve in place is released and the sliding sleeve is freed to move axially within the bore. As the sliding sleeve slides further into the bore, it typically exposes a window opening housing the first ferrule, which is typically mounted on a pivot arm, in a sealed chamber inside the pin. In this example, the ferrules in each of the first and second connector parts are protected in chambers (e.g. sealed chambers) prior to final stages of mating, which are optionally pressure-compensated, and can be filled with a fluid such as a gel, which can be thixotropic, and can be optically compatible with the optical fibres, and which optionally incorporates scavengers such as Hydrogen scavengers for example. Embodiments of the present invention thus have the advantage that they can be used in harsh environments such as underwater or in downhole applications, and the ferrules are always protected from the outer environment, in that they are retained in chambers (e.g. sealed chambers) when the two parts are not connected and are also protected during the connection process, such that they are never exposed to the potentially harsh outer environment. Optionally the chambers in the first and second connector parts can communicate when mated. In this case, the first ferrule is mounted in a sealed chamber in the pin. The window is sealed by the sliding sleeve. Exposing the window opening as the sliding sleeve moves down the pin opens the chamber and frees the first ferrule to move radially outward on a pivot arm, which is typically biased radially outwards by a coil, leaf or torsion spring etc. This moves the first ferrule radially into a position which is in radial alignment with second ferrule (in other words, the distance between the common central axis of the first and second connector parts and the first and second ferrules is within a close tolerance, for example, within 10%, or 5%, or 1-2%, although at this stage in the mate, the rotational positions of the first and second ferrules are not yet fully aligned (in other words the first and second ferrules may be at different circumferential positions, within the ±10-30° of the initial rough circumferential alignment.

Continued axial movement of the first and second connector parts together typically moves the first ferrule axially further into the pocket of the guide assembly. The circumferential distance of the wide mouth at the open end of the pocket in the capture cone on the guide assembly is typically wide enough to accept the first ferrule when the first and second connector parts are in rough circumferential alignment. In examples where the rough circumferential is ±15°, wide mouth of the capture cone can be at least the same 30° for instance.

Continued axial closure between the first and second connector parts moves the first and second ferrules together, which causes the first ferrule to abut against one of the tapered edges of the capture cone in the pocket of the guide assembly. Since the first ferrule is rotationally fixed to the first connector part, and since the second ferrule is free to rotate relative to the second connector part, this causes the relative rotation of the second ferrule with the guide assembly around the axis of the second connector part relative to the rotationally static first ferrule, thereby drawing the second ferrule on the guide assembly into more precise circumferential alignment with the first ferrule as the first ferrule nudges the guide assembly in rotation around the common axis relative to the circumferential position of the first ferrule, to adjust and typically to increase the degree of alignment between the first and second ferrules.

In a further and optionally a final stage of alignment, alignment pins on one of the ferrules (e.g. the pins can optionally be on the second ferrule) enter the bores of the other ferrule.

Optionally the assembly comprises an over-stroke mechanism adapted to limit the force applied to the ferrules in an axial direction during connection.

Optionally one of the first and second ferrules (e.g. the second ferrule) is biased axially in a direction parallel to the common axis, for example, by at least one compression spring, which urges the ferrules into axial contact. Axial mating of the first and second ferrules in at least one stage of the mate (e.g. in the final stage of connection where the alignment pins on one ferrule enter the bores of the other) typically energises the compression spring(s) and urges the first and second ferrules together in an axial direction relative to the first and second connector parts, typically until there is at least a 1 mm axial engagement between the ferrules (e.g. at least a 1 mm compression of the spring).

In certain examples, this provides a required pre-load force for the mate, ensuring that the ferrules are axially driven into contact. Continued axial closure past this point optionally engages the overstroke mechanism, limiting or avoiding excessive axial force which might tend to damage the delicate structure of the alignment pins and bores, and the ferrule fibres. Optionally the compression spring of the over-stroke mechanism permits up to +7 mm over-stroke in an axial direction, while maintaining the typical 1 mm engagement of the ferrules and a suitable pre-load.

Optionally at the ends of the first and second connector parts that are opposite to the mating ends, the optical fibres are terminated in optical fibre penetrators, and optionally a continuous length of optical fibre extends between the ferrules and the penetrators, optionally avoiding the requirement for a fibre splice.

Optionally the first and second ferrules are biased axially together by a preload force of for example, 10N when mated, and the compression spring(s) biasing the guide assembly on the first connector part are typically calibrated to apply the necessary axial force and to achieve the desired axial engagement of the ferrules (e.g. 1 mm of engagement) from first contact.

During the mate sequence and once the desired pre-load has been achieved typically the shuttle pin engages with the guide assembly and urges the guide assembly back into the bore of the second connector part, typically thereby energising the over-stroke spring, and typically limiting compression of springs acting on the second ferrule, thus limiting any additional axial loads on the second ferrule. The ideal mated position of the connector in one example is a further 3.5 mm of stroke but a total over-stroke of 7 mm can be accommodated, giving a ±3.5 mm mate tolerance.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the spirit and scope of the present invention. Accordingly, each example herein should be understood to have broad application, and is meant to illustrate one possible way of carrying out the invention, without intending to suggest that the scope of this disclosure, including the claims, is limited to that example. Furthermore, the terminology and phraseology used herein is solely used for descriptive purposes and should not be construed as limiting in scope. In particular, unless otherwise stated, dimensions and numerical values included herein are presented as examples illustrating one possible aspect of the claimed subject matter, without limiting the disclosure to the particular dimensions or values recited. All numerical values in this disclosure are understood as being modified by “about”. All singular forms of elements, or any other components described herein are understood to include plural forms thereof and vice versa.

Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers. Other technical features may be readily apparent to one skilled in the art from the following figures, descriptions, and claims.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee.

### BRIEF DESCRIPTION OF THE DRAWINGS

In the accompanying drawings:

FIGS. 1 & 2 show first and second connector parts unmated;

FIGS. 3 & 4 show expanded views of the mating ends of the connector parts in FIGS. 1 and 2;

FIG. 5 shows a perspective view of a guide assembly of the second connector part of FIG. 2;

FIG. 6 shows a sectional view through the connector parts in a first stage of mating where the ferrules are spaced apart;

FIGS. 7a, b, and c show the same connector parts in a second stage of connection, where the ferrules have just made contact, with FIGS. 7b, and c showing magnified views of internal components in the first and second connector parts during mating;

FIGS. 8a, b, and c show the same connector parts in a third and final stage of connection, where the ferrules are being urged together in an axial direction, with FIGS. 8b, and c showing magnified views of internal components in the first and second connector parts during mating and

FIGS. 9-11 show perspective views of the internal components surrounding the guide assembly during mating.

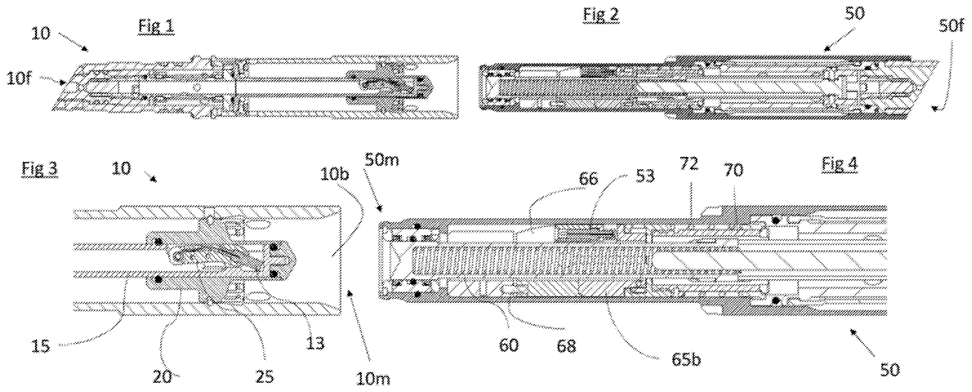

### DETAILED DESCRIPTION OF ONE OR MORE EXAMPLES

Referring now to the drawings, an optical fibre connector assembly has first and second connector parts 10, 50 adapted to interconnect along a common axis shared by the two parts 10, 50. In this example, the left hand end of the first connector part shown in the drawings 10 faces downward, and the right hand end of the second connector 50 faces upward, but this can clearly be changed in different examples. Each part 10, 50 has at least one optical fibre (typically multiple optical fibres). Each optical fibre typically forms a continuous length along each connector part, extending between a fixed end which typically houses a penetrator where the optical fibre passes through the end of the connector part, and a mating end, where the optical fibre terminates in an optical ferrule. The first connector part 10 has a first optical fibre terminating in a first ferrule 13, and the second connector part 50 has a second optical fibre terminating in a second ferrule 53. When connected, the first and second ferrules 13, 53 connect together to transmit a signal between the first and second optical fibres in the first and second connector parts 10, 50.

The first connector part 10 is typically connected to a wellhead at its lower fixed end 10f. The penetrator at the fixed end 10f contains wellbore pressures in the well below. The outer housing of the first connector part 10 typically forms a receptacle and has a bore 10b open at the opposite mating end 10m, which receives a bullnose on a tubular outer housing at the mating end 50m of the second connector part 50, typically disposed above the first connector part 10 in a vertical orientation, typically on a tree that is landed on the wellhead during the mating process. The second connector part 50 typically forms a plug which is received within the receptacle of the first connector part 10. The upper fixed end 50f of the second connector part 50 likewise has a penetrator to seal the second connector part 50 at the upper end. The first and second connector parts 10, 50 are initially brought into rough circumferential alignment with each other before mating, for example, by roughly aligning outer markers on the outer housings before deployment. Precise circumferential alignment at this stage is unnecessary, and it is sufficient that the relative circumferential alignment between the first and second connector parts is within around 30° e.±15°, since more precise circumferential alignment is achieved in later stages of the mate. The bore 10b has an annular capture cone formed on the opening of the outer housing. The minor diameter of the capture cone has a close tolerance for example, within 3%, or 2%, or 1% with the outer diameter of the second connector part 50, so that the passage of the bullnose of the second connector part 50 into the capture cone of the bore 10b aligns the two connector parts relatively precisely on a common axis.

The bore 10b in the outer housing of the first connector part 10 houses an axially extending pin 15, which is co-axial with the central long axis of the first connector part 10, and co-axial with the bore 10b. The pin 15 supports a sliding sleeve 20, which extends radially between the outer surface of the pin 15 and the inner surface of the bore 10b, and which is slidable axially along the bore 10b and the shaft of the pin 15. The sliding sleeve 20 has an inner end facing the fixed end 10f and an outer end facing the free or mating end 10m of the connector part 10. The sliding sleeve 20 is held axially in place in the bore of the housing by a snap ring, located in a recess on the inner surface of the bore.

The tubular bullnose at the mating end 50m of the second connector part 50 enters the bore of the housing of the first connector part 10 at the first stage of mating, and seats on the outer end of the sliding sleeve 20. A convex end of the pin 15 seats on a concave recess on the end of a shuttle pin 60 in the second connector part 50, pushing the shuttle pin 60 back into the housing of the second connector part 50 and energising a compression spring urging the shuttle pin 60 towards the mating end 50m. At this stage, the ferrules 13, 53 have not yet made contact. Continued relative closure of the two connector parts advances the bullnose into the bore 10b, and releases the snap ring, and the bullnose on the outer housing of the second connector part 50 continues to push the sliding sleeve 20 down the shaft of the pin 15, while the pin 15 on the first connector part continues to push the shuttle pin 60 into the second connector part 50 as best shown in FIG. 6 for example.

The pin 15 houses the first ferrule 13 in the first connector part 10, and in this example, the first ferrule is mounted on an arm 25 which is mounted on a pivot inside the bore of the pin 15, adjacent to a window in the pin 15, such that in one configuration, where the arm 25 is radially retracted, the first ferrule 13 is within the bore of the pin 15 and does not protrude out of the window, and wherein in a second configuration, where the arm 25 is radially extended, the ferrule has pivoted radially outwards towards the inner surface of the bore 10b in the outer housing, and extends out of the window. The arm 25 is axially secured to the pin 15. The arm 25 is typically urged to move the first ferrule 13 by a torsion spring for example. The arm 25 is maintained in the first configuration with the first ferrule 13 within the bore of the pin 15 when the sliding sleeve 20 is covering the window. Sliding movement of the sliding sleeve 20 on the pin 15 uncovers the window and allows the radial movement of the arm 25 urged by the spring. This pivots the first ferrule 13 in an arc radially into a position which is in radial alignment with second ferrule 53 (in other words, the distance between the common axis of the first and second connector parts 10, 50 and the first and second ferrules 13, 53 is within a close tolerance, for example, within 3%, or 2%, or 1%, although at this stage in the mate, the rotational positions of the first and second ferrules 13, 53 are not yet fully aligned (in other words the first and second ferrules may be at different circumferential positions, within the ±10-30° of the initial rough circumferential alignment). Note that the pin 15 is fixed in relation to the first connector part 10, and so while the arm 25 is free to move in the arc around the pivot, once it reaches the radially extended position, it is not thereafter movable axially relative to the first connector part 10.

The sliding sleeve 20 typically seals the first ferrule 13 and optical fibre in a gel filled environment. In this example, the ferrules in each of the first and second connector parts are typically protected in sealed chambers which are pressure-compensated, and filled with a fluid such as a thixotropic gel, which is optically compatible with the optical fibres. This provides the great advantage that the ends of the first and second optical fibres are protected within their respective chambers when the first 10 and second 50 connector parts are separated and are also still protected within their respective chambers for the initial stages of interconnection and are still protected from the outer environment during the latter stages of interconnection (by virtue of the seal arrangement which keeps the outer environment from being able to contact the fibre optic cable ends even as the first ferrule 13 is being brought into alignment with the second ferrule and/or is brought into contact with the same during the interconnection process) and therefore embodiments of the present invention can be used in relatively harsh environments such as underwater or downhole in an oil or gas wellbore. Typically the second connector part (optionally an inner surface of the bullnose of the second connector part) seals onto the pin before the sliding sleeve uncovers the window. In an unmated state the front seals of the second connector part 50 block ingress of fluids into the bore of the second connector part 50 by sealing against the shuttle pin 60. With continued axial closure the shuttle pin 60 is pushed back into the bore, the front seals transfer to the sliding sleeve 20, and the integrity of the mated pair of connectors is thereby maintained, with the sliding sleeve 20 also sealing against the first connector part pin 15.

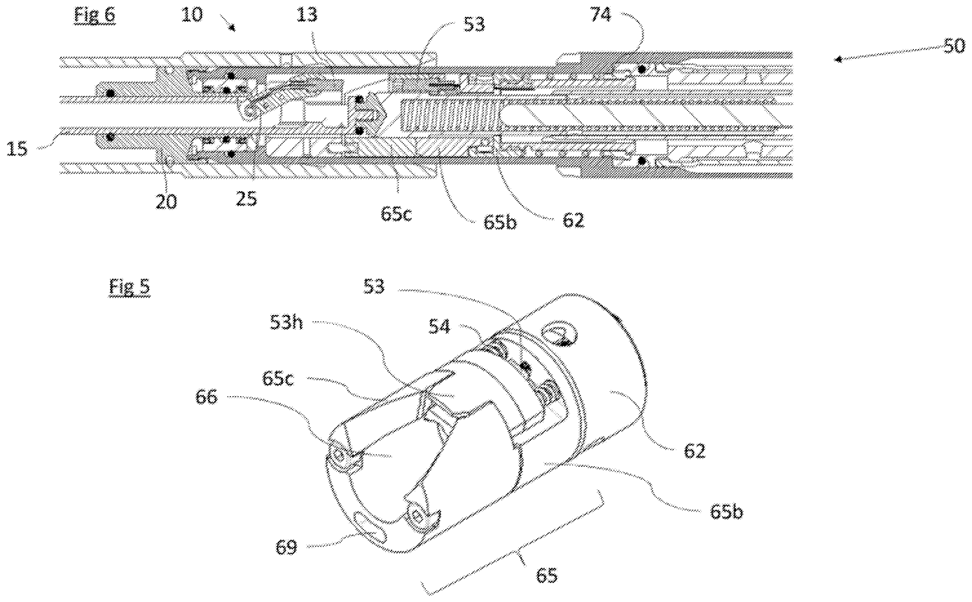

In the second connector part 50, the second ferrule 53 is mounted on a guide assembly comprising in this example a guide collar 65, best seen in FIG. 5. The guide collar 65 is generally formed as a sleeve formed as a sliding fit within the outer housing and mounted around the shaft of the shuttle pin 60, and is rotationally connected to the second ferrule 53, which rotates with the guide collar 65. In this example, the guide collar 65 is formed in multiple (e.g. two) parts, each part typically being formed as an annular sleeve with typically a common axis. In this example, a guide collar body 65b is connected at one outer end (closest to the mating end 50m) to a capture cone 65c. Typically at the other inner end (facing away from the mating end 50m) the guide collar body 65b is rotationally connected to a bearing housing 62 which houses a bearing permitting free rotation of the guide collar body 65b (and typically the capture cone 65c which is typically fixed to the guide collar body 65b) relative to the bearing housing 62 and the rest of the second connector part 50. The bearing housing is not essential, but the bearing reduces friction during rotation of the guide collar, which is beneficial.

The body 65b of the guide collar 65 typically has a segment displaced from the axis forming a flat surface adapted to receive a second ferrule housing 53h, The second ferrule 53 is mounted in the ferrule housing 53h in the flat segment (optionally movably mounted allowing axial movement of the second ferrule 53 relative to the guide collar 65 but not rotational movement, and optionally biased towards the capture cone 65c and away from the bearing housing 62 by means of compression springs 54).

The pocket 66 is adapted to guide interconnection of the first and second ferrules during connection. The pocket 66 has tapered sides spaced circumferentially apart and is adapted to receive the first ferrule 13 during mating. The body 65b and the capture cone 65c of the guide collar 65 have a common central axis that is co-axial with the axis of the second connector part and the shuttle pin 60, and is therefore co-axial with the common axis of the two connector parts 10, 50. The guide collar body 65b and capture cone 65c are typically rotatable as a unit around the axis of the second connector part (and therefore the common axis) during interconnection of the first and second ferrules. In this example, the whole of the guide collar 65 is rotatable as a unit relative to the bearing assembly 62.

Whereas the bearing housing 62 forms a generally annular ring, the body 65b and the capture cone 65c are not symmetrical around the central axis, as the pocket 66 and the second ferrule 53 are displaced radially from the central axis. The body 65b and capture cone 65c are typically fixed together by fixings such as bolts extending through the parts, visible in FIG. 5, so that the assembly of the two components of the body 65b and capture cone 65c can rotate together as a single unit around the bearings in the bearing housing 62, which facilitates rotational movement of the guide collar 65.

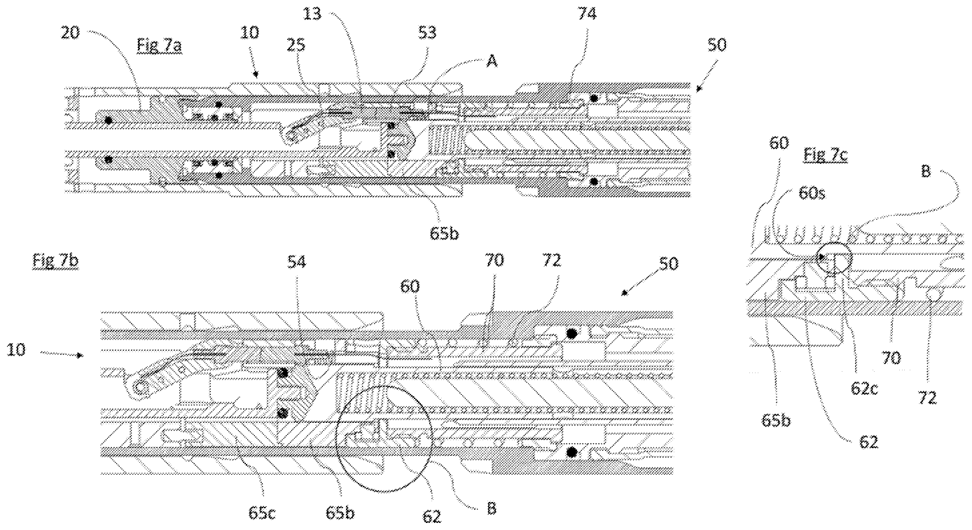

The pocket 66 is symmetrically tapered with one open end (facing the mating end 50m in this case) adapted to receive the first ferrule 13, and one closed end (facing away from the mating end 50m in this case). The open end of the pocket 66 has a mouth which is wider than a throat of the pocket at the opposite end of the pocket. The throat of the pocket 66 and the second ferrule 53 are typically radially spaced from the axis by the same distance, so that they are in the same radial plane. Continued axial movement of the first and second connector parts 10, 50 together typically moves the first ferrule 13 axially into the pocket 66 of the guide collar 65 as shown in FIGS. 7a, b & c. The circumferential distance of the wide mouth of the capture cone on the guide collar 65 is typically wide enough to accept the first ferrule 13 when the first and second connector parts 10, 50 are in rough circumferential alignment. In examples where the rough circumferential alignment required for initial mating is ±15°, a wide mouth of the capture cone can have at least the same angular dimension e.g. 30° in this example.

Continued axial closure between the first and second connector parts 10, 50 beyond the FIG. 6 position closes the axial spacing between the first and second ferrules 13, 53, moving them axially together, which causes the first ferrule to abut against one of the tapered edges of the capture cone in the pocket 66. Since the first ferrule 13 is rotationally fixed to the first connector part 10, and since the second ferrule 53 is free to rotate with the guide collar 65 around the axis of the second connector part 50, this axial closure between the ferrules causes the relative rotation of the second ferrule (with the guide collar 65) around the axis second connector part 50 relative to the rotationally static first ferrule 13, thereby rotating the second ferrule 53 on the guide collar 65 into more precise circumferential alignment with the first ferrule 13. In other words, as the first ferrule 13 advances into the mouth of the pocket 66, the pocket 66 narrows and gradually reduces the available space for relative circumferential movement between the first and second ferrules 13, 53, until the first ferrule 13 is in the throat of the pocket 66, at which point the sides of the pocket 66 engage the first ferrule 13 on at least two circumferentially spaced sides of the pocket 66, resisting or preventing relative circumferential movement between the first and second ferrules 13, 53 out of rotational alignment. Thus, the first ferrule 13 typically “nudges” the guide collar 65 in rotation around the common axis thereby increasing the circumferential alignment between the first and second ferrules 13, 53 until the first ferrule 13 and the guide collar 65 are rotationally connected and in closer circumferential alignment when the first ferrule 13 is lodged in the throat. The tapered sides of the pocket are typically symmetrical around a central axis. The second ferrule 53 mounted on the guide collar 65 is mounted at the throat and on the same axis as the throat, so that when the first ferrule 13 has advanced axially into the throat and causes the guide collar 65 to rotate relative to the first ferrule 13, the first ferrule 13 draws the guide collar 65 and therefore the second ferrule 53 at the end of the throat and on the same axis as the throat into closer circumferential alignment with the axially moving but rotationally static first ferrule 13. This increases the circumferential alignment between the first and second ferrules 13, 53 during the mate.

In this example, the guide collar 65 is rotationally fixed to the second ferrule 53 (such that the two rotate together in the bore of the second connector part 50) and is rotatable around the common axis of the first and second connector parts 10, 50 when interconnected. The range of relative rotation is typically limited by a pin 68 that is rotationally fixed with respect to the first connector part 10, and which engages in a curved slot 69 in the guide assembly. In this example, the range of permitted relative rotation is 30° e.g. ±15°.

As the relative axial movement of the first and second ferrules 13, 53 within the second connector part progresses from the FIG. 6 position to the FIG. 7 position, it can be seen that this drives rotational movement of the guide collar 65 relative to the first ferrule 13 between a first rotational position in which the first ferrule 13 is axially spaced apart from the second ferrule 53 and the first and second ferrules 13, 53 are circumferentially misaligned and in which the first and second optical fibres are not in communication, and a second rotational position in which the first and second ferrules 13, 53 are axially engaged and circumferentially aligned and the first and second optical fibres are in communication.

The first and second ferrules 13, 53 on their opposing mating ends typically incorporate at least two highly toleranced pins in one ferrule which align with highly toleranced bores in the other ferrule. In the final stage of mating just prior to the position in FIG. 7, the pins enter the bores and ensure that first contact of the fibres of both halves of the connector are adjacent and aligned.

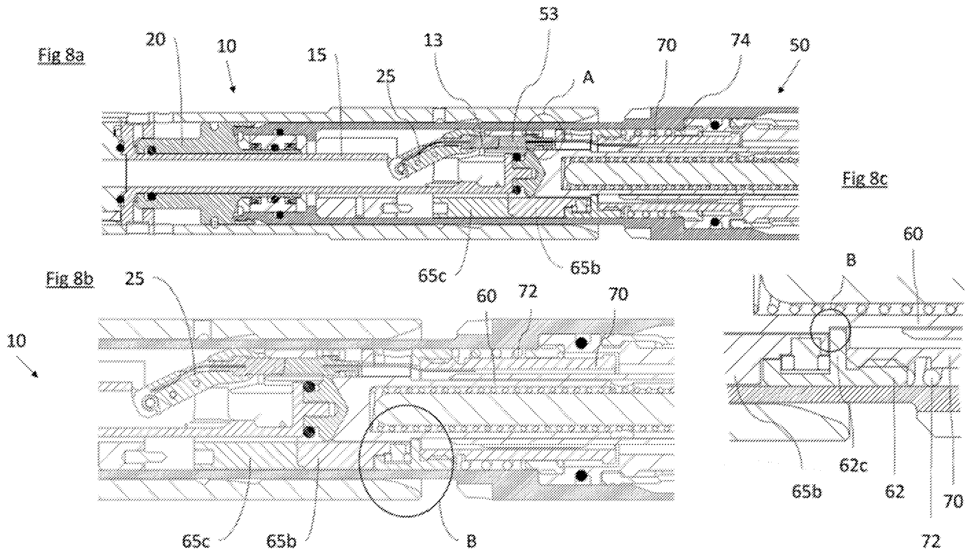

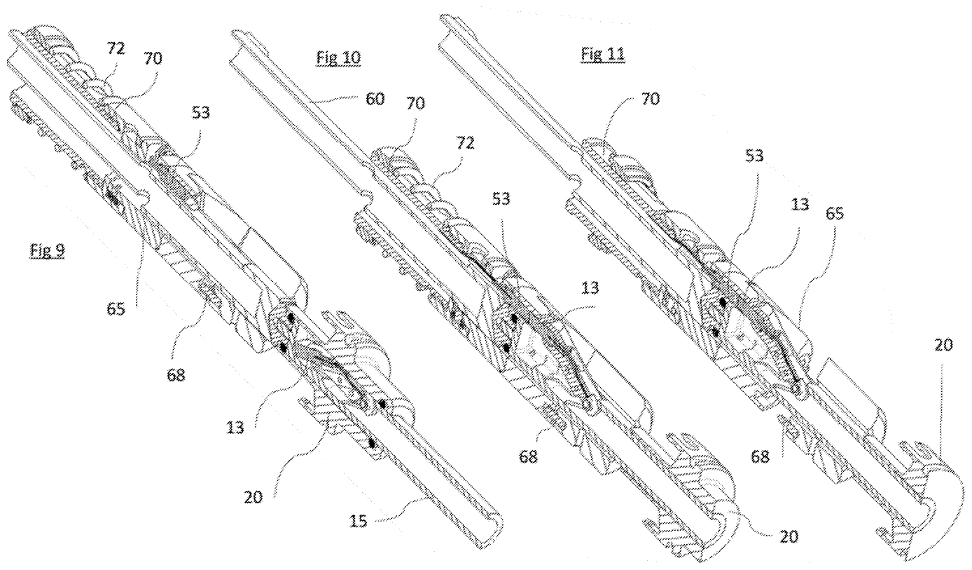

Optionally the assembly comprises an over-stroke mechanism adapted to limit the force applied to the ferrules in an axial direction during connection. In this example, an overstroke sleeve 70 is housed in the bore of the second connector portion 50, biased out of the bore by a spring 72. The overstroke sleeve 70 is best seen in FIGS. 7 and 8, with FIGS. 7b, 7c, 8b & 8c showing detailed views of the interaction between the overstroke sleeve 70, the shuttle pin 60, and the guide collar 65 in the last two stages of mating. FIGS. 7a, b & c all show the same view at different magnifications. Likewise FIGS. 8a, b & c all show the same view at different magnifications.

The spring 72 is preloaded in compression between a lock ring 74 fixed in the bore at an inner end of the overstroke sleeve 70, and an inner end of the bearing housing 62 which is connected by a screw thread to an outer end of the overstroke sleeve 70. The spring 72 urges the overstroke sleeve 70 (and the bearing housing 62) in an axial direction out of the bore of the second connector portion 50, but the lock ring 74 acts to limit the maximum extension beyond the FIG. 6 position. The bearing housing 62 has a radially inwardly extending collar 62c with an outer surface facing the lower (mating) end 50m.

Optionally one of the first and second ferrules (e.g. the second ferrule) is separately biased relative to the bearing housing 62 axially in a direction parallel to the common axis by at least one and typically a pair of springs 54 (best seen in FIG. 5) preloaded in compression between the second ferrule housing 53h and a shoulder in the body 65b of the guide collar 65 urging the second ferrule 53 towards the open mating end 50m of the second portion. Axial mating of the first and second ferrules 13, 53 in at least one stage of the mate (e.g. in the final stage of connection shown in FIG. 8 where the alignment pins on one ferrule enter the bores of the other) typically energises the springs 54 in the guide collar 65 and moves the first and second ferrules together in an axial direction relative to the first and second connector parts 10, 50, typically until there is at least about a 1 mm axial engagement between the ferrules, or in other words about a 1 mm compression of the springs 54, as can be seen contrasting FIGS. 7 and 8.

FIGS. 7a, b & c show the configuration just as the ferrules touch for the first time and before the springs 54 are compressed, and shows the same axial spacing between the ferrule housing 53f and the bearing housing 62 as in the previous stage in FIG. 6. Note that at this stage, the lock ring 74 is limiting the extension of the overstroke sleeve 70 from the second connector part 50, and the overstroke spring 72 is not yet seeing any additional compression as compared with the FIG. 6 position before initial contact between the ferrules 13, 53.

Note also that the outer surface of the collar 62c on the bearing housing and the inwardly oriented shoulder 60s on the shuttle pin 60 are still axially spaced apart by about 1 mm, as shown in detail B in FIGS. 7b &c, and that in the FIG. 7 position, the first and second ferrules 13, 53 have only just touched for the first time, and at this stage there is no axial force applied between them. Further, in the FIG. 7 position, the springs 54 are not seeing any additional compression beyond their initial preload, and the axial spacing between the second ferrule 53 and the guide collar body 65b is the same as in FIG. 6 (see detail A in FIG. 7). Finally, as shown in FIG. 7, the inner end of the sleeve 20 has not yet bottomed out on the inner end of the bore 10b.

Once the shoulder 60s and the outer surface of the collar 62c move past the FIG. 7 position, the distance between the shoulder 60s on the shuttle pin 60 and the bearing housing 65b of the guide collar 65 reduces, and the continued movement of the second connector part 50 into the bore 10b of the first connector part 10 starts to compress the springs 54 further beyond their initial preload. The additional load that can be applied to the springs 54 is determined in this example by the distance the first connector part can move after the FIG. 7 position when the first and second ferrules first touch, until the shoulder 60s on the shuttle pin engages the outer surface of the collar 62c, which in this example is set at around 1 mm. Further axial movement of the second connector part 50 into the bore 10b beyond the position at which the shoulder 60s and the collar 62c engage typically drives the guide assembly 65 into the bore 10b, but does not affect the loading on the springs 54, or the relative positions of the first and second ferrules 13, 53, because the shoulder 60s on the shuttle sleeve 60 pushes the bearing housing 62 as a whole and the guide assembly 65 to which it is attached further into the bore of the second connector part 50, compressing the overstroke spring 72, and sliding the overstroke sleeve 70 into the bore of the second portion.

FIGS. 8a, b & c show the next (and final) stage. In the FIG. 8 position, the first and second ferrules 13, 53 are urged together and the springs 54 are fully compressed to the desired additional loading, but the axial distance between them has not changed since the initial engagement of the shoulder 60s and the collar 62c. FIG. 8 shows the reduction in the axial spacing between the ferrule housing 53f and the bearing housing 62 (at detail A), the axial engagement between the collar 62c and the body 65b of the guide collar 65 (at circle B), and the sliding of the overstroke sleeve 70 into the bore of the second connector portion 50 relative to the lock ring 74, thereby compressing the overstroke spring 72.

After the compression of the springs 54 and the engagement of the shoulder 60s on the collar 62c, any continued axial closure merely compresses overstroke spring 72, rather than applying any additional forces to the ferrules 13, 53, which typically move together with the shuttle pin 60 during axial closure between the first and second connector parts 10, 50, thereby limiting or avoiding excessive axial force which might tend to damage the delicate structure of the alignment pins and bores, and the ferrule fibres, and this can usefully control the pre-load force for the mate.

As the axial closure continues, in the final stage shown in FIGS. 8a, b & c, the collar 62c on the bearing housing 62 (which is attached to the inner end of the guide collar 65) engages with the shoulder 60s on the shuttle pin (see the circle detail B in FIGS. 8b & c and the contrast between the same sections in FIGS. 7b & c). Any further axial closure results in the shuttle pin shoulder 60s also moving the guide collar 65 axially with it, thereby isolating any additional compressive force from the springs 54, which limits axial loads between the ferrule 13 and 53 even if higher loads are applied during the overstroke beyond that stage. The ideal final mated position of the connector in this example is a further 3.5 mm of stroke of the second connection portion 50 relative to the first connector portion 10 past the position shown in FIG. 7, but a total over-stroke of 7 mm can be accommodated, giving a ±3.5 mm mate tolerance. Optionally the compression spring 72 biasing the overstroke sleeve 70 permits up to +7 mm over-stroke in an axial direction, while the typical 1 mm engagement of the ferrules 13 and 53 is maintained with a suitable pre-load. Optionally the first and second ferrules are biased axially together by a preload force of for example, 10N when mated, and the compression springs 54 biasing the guide assembly on the first connector part is typically calibrated to apply the necessary axial force and to achieve the desired axial engagement of the ferrules (e.g. 1 mm of engagement) from first contact. Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An optical fibre connector assembly comprising:
first and second connector parts adapted to interconnect, each of the first and second connector parts having an axis;
a first optical fibre terminating in a first ferrule in the first connector part, and a second optical fibre terminating in a second ferrule in the second connector part, the first and second ferrules being adapted to interengage to transmit a signal between the first and second connector parts;
wherein the second connector part comprises a guide assembly connected to the second ferrule and adapted to guide interengagement of the first and second ferrules, the guide assembly having a pocket adapted to receive the first ferrule during interengagement of the first and second ferrules; and
wherein at least a part of the guide assembly is rotatable around the axis of the second connector part during interengagement of the first and second ferrules.

2. The optical fibre connector assembly as claimed in claim 1, wherein relative axial movement of the first and second ferrules within the connector assembly is adapted to drive rotational movement of the rotatable part of the guide assembly relative to the first ferrule between a first rotational position in which the first ferrule is axially spaced apart from the second ferrule and the first and second ferrules are circumferentially misaligned and in which the first and second optical fibres are not in communication, and a second rotational position in which the first and second ferrules are axially engaged and circumferentially aligned and the first and second optical fibres are in communication.

3. The optical fibre connector assembly as claimed in claim 1, wherein the guide assembly comprises a guide collar in the form of a sleeve, having a bore with an axis which is co-axial with the axis of the first connector part.

4. The optical fibre connector assembly as claimed in claim 1, wherein the pocket has an outer end adapted to receive the first ferrule, and an inner end, wherein the outer end of the pocket has a mouth which is circumferentially larger than the first ferrule, and wherein the inner end of the pocket has a throat which is circumferentially no larger than the first ferrule, whereby when the first ferrule is in the throat the sides of the pocket engage the first ferrule on at least two circumferentially spaced apart sides of the first ferrule, resisting or preventing relative circumferential movement between the first and second ferrules.

5. The optical fibre connector assembly as claimed in claim 1, wherein the pocket is symmetrical around a central axis of the pocket.

6. The optical fibre connector assembly as claimed in claim 1, wherein the guide assembly is rotationally fixed with respect to the second ferrule, and is rotatable around a central axis of the second connector part.

7. The optical fibre connector assembly as claimed in claim 1, wherein the range of rotation of the guide assembly relative to the second connector part is limited by a pin fixed to the first connector part, and engaged in a slot in the guide assembly.

8. The optical fibre connector assembly as claimed in claim 1, wherein at least one of the first and second ferrules is arranged to move radially relative to a common axis of the first and second connector parts during mating, between a first radial position in which the distances between the common axis and the first and second ferrules are different, and a second radial position in which the distances between the common axis and the first and second ferrules are the same.

9. The optical fibre connector assembly as claimed in claim 1, wherein interaction of the first ferrule with the guide assembly is adapted to change the rotational orientation of the second ferrule with respect to the first connector part.

10. The optical fibre connector assembly as claimed in claim 1, wherein the first ferrule is rotationally fixed to the first connector part, and the second ferrule is free to rotate relative to the second connector part.

11. The optical fibre connector assembly as claimed in claim 1, including an overstroke mechanism adapted to bias the second ferrule axially in a direction parallel to the common axis which urges the first and second ferrules into axial contact, and wherein the compression spring is adapted to maintain the axial force transmitted between the first and second ferrules during mating within a limited range.

12. The optical fibre connector assembly as claimed in claim 11, wherein the overstroke mechanism comprises an overstroke sleeve biased by an overstroke spring to urge the guide assembly in an axial direction toward the first ferrule.

13. The optical fibre connector assembly as claimed in claim 12, including a stop member adapted to limit relative movement of the first and second ferrules after axial movement of the overstroke sleeve engages a shoulder with the stop member.

14. The optical fibre connector assembly as claimed in claim 12, wherein after engagement of the stop member and the shoulder, the first and second ferrules move together in the bore of the first connector part during axial movement of the second connector portion into the bore of the first connector portion.

15. The optical fibre connector assembly as claimed in claim 1, wherein the second ferrule is biased relative to the guide assembly in an axial direction toward the first ferrule by a resilient device held in compression between the second ferrule and a shoulder on the guide assembly.

16. The optical fibre connector assembly as claimed in claim 1, wherein the first ferrule and the first optical fibre terminating therein are housed within a chamber and the second ferrule and the second optical fibre terminating therein are housed within a chamber.

17. The optical fibre connector assembly as claimed in claim 16, wherein both of said chambers are sealed from the outer environment when the first and second connector parts are separated from one another.

18. The optical fibre connector assembly as claimed in claim 17, wherein both of said chambers are arranged to be sealed when the first and second connector parts are brought into mating connection with one another up until a final stage of mating, such that each of the ferrules are protected from exposure to the outer environment.

19. A method of transmitting an optical signal between first and second optical fibres, the method comprising:
terminating first and second optical fibres in optical ferrules housed in respective first and second connector parts, the first and second ferrules being adapted to interengage to transmit a signal between the first and second connector parts, and each of the first and second connector parts having an axis;
wherein the second connector part comprises a guide assembly connected to the second ferrule and adapted to guide interengagement of the first and second ferrules, the guide assembly having a pocket adapted to receive the first ferrule during interengagement of the first and second ferrules; and
wherein the method includes rotating the guide assembly around the axis of the second connector part during interengagement of the first and second ferrules.

20. The method as claimed in claim 19, including driving rotational movement of the guide assembly relative to the first ferrule between a first rotational position in which the first ferrule is axially spaced apart from the second ferrule and the first and second ferrules are circumferentially misaligned and in which the first and second optical fibres are not in communication, and a second rotational position in which the first and second ferrules are axially engaged and circumferentially aligned and the first and second optical fibres are in communication, wherein the rotational movement of the guide assembly is driven by relative axial movement of the first and second ferrules.

21. The method as claimed in claim 19, wherein the pocket has an outer end adapted to receive the first ferrule, and an inner end, wherein the outer end of the pocket has a mouth which is circumferentially larger than the first ferrule, and wherein the inner end of the pocket has a throat which is circumferentially no larger than the first ferrule, and wherein the method includes moving the first ferrule axially into the throat until the sides of the pocket engage the first ferrule on at least two circumferentially spaced apart sides of the first ferrule, thereby resisting or preventing relative circumferential movement between the first and second ferrules.

22. The method as claimed in claim 20, wherein the pocket is symmetrical around a central axis of the pocket.

23. The method as claimed in claim 19, including rotationally fixing the guide assembly to the second ferrule.

24. The method as claimed in claim 19, including rotationally fixing the first ferrule to the first connector part.

25. The method as claimed in claim 19, including limiting a range of rotation of the guide assembly relative to the second connector part.

26. The method as claimed in claim 19, including changing the rotational orientation of the second ferrule with respect to the first connector part by interaction of the first ferrule with the guide assembly.

27. The method as claimed in claim 19, including limiting an axial force transmitted between the first and second ferrules during mating.

28. An optical fibre connector assembly comprising:
first and second connector parts adapted to interconnect, each of the first and second connector parts having an axis;
a first optical fibre terminating in a first ferrule in the first connector part, and a second optical fibre terminating in a second ferrule in the second connector part, the first and second ferrules being adapted to interengage to transmit a signal between the first and second connector parts;
wherein the first ferrule is rotationally fixed to the first connector part;
wherein the second connector part comprises a guide assembly connected to the second ferrule and adapted to guide interengagement of the first and second ferrules;
wherein the guide assembly is rotationally fixed with respect to the second ferrule;
wherein the guide assembly has a pocket adapted to receive the first ferrule during interengagement of the first and second ferrules;
wherein at least a part of the guide assembly is freely rotatable around the axis of the second connector part during interengagement of the first and second ferrules; and
wherein relative axial movement of the first and second ferrules within the connector assembly is adapted to drive rotational movement of the guide assembly relative to the first ferrule between a first rotational position in which the first ferrule is axially spaced apart from the second ferrule and the first and second ferrules are circumferentially misaligned and in which the first and second optical fibres are not in communication, and a second rotational position in which the first and second ferrules are axially engaged and circumferentially aligned and the first and second optical fibres are in communication.
